(19) United States
(12) Patent Application Publication
(10) Pub. No.: US 2024/0407305 A1
(43) Pub. Date: Dec. 12, 2024

(54) SYSTEM AND METHOD FOR VERTICAL FARMING

(71) Applicant: Inevitable Technology Inc., Lockhart, TX (US)

(72) Inventors: Jacob Dooris, Zephyr Cove, NV (US); Gregory Borowski, Austin, TX (US); Thomas Kendall, San Jose, CA (US)

(73) Assignee: Inevitable Technology Inc., Lockhart, TX (US)

(21) Appl. No.: 18/739,216

(22) Filed: Jun. 10, 2024

Related U.S. Application Data
(60) Provisional application No. 63/472,538, filed on Jun. 12, 2023.

(51) Int. Cl. A01G 9/02; A01G 9/24; A01G 27/00

(52) U.S. Cl. CPC A01G 9/023; A01G 9/241; A01G 9/249; A01G 27/008

(57) ABSTRACT

A vertically-oriented module for growing plants is disclosed where the module comprises: a base comprising a housing for one or more auxiliary systems that support the module; a silo positioned on top of the base, the silo comprising a central core; an outer frame surrounding the central core, the outer frame defining a plurality of columns arranged radially around the central core, wherein each column is configured to receive one or more removable panels of plants; and a plurality of lighting units coupled to and arranged radially around the central core such that each lighting unit projects light away from the central core towards a corresponding column in the outer frame

### CROSS-REFERENCES TO RELATED APPLICATIONS

This application claims priority to U.S. Provisional Patent Application No. 63/472,538, filed Jun. 12, 2023, the contents of which are hereby incorporated by reference in its entirety.

### TECHNICAL FIELD

This invention relates generally to the field of agricultural systems and more specifically to a new and useful system and method for propagating seeds to seedlings within an agricultural facility in the field of agricultural systems.

### BACKGROUND OF THE INVENTION

Global Warming is the long-term warming of the planet's overall temperature. While this warming trend has been going on for a long time, scientists believe almost uniformly that its pace has increased in the last hundred years due to the burning of fossil fuels and other human-induced activities that generate gases which contribute to what scientists refer to as the “greenhouse effect”. Greenhouse gases form a layer in the upper atmosphere of the planet that is more transparent to visible radiation from the sun than to infrared radiation emitted from the planet's surface. Thus, as the sun's radiation warms the surface of the earth, the earth's atmosphere prevents some of the heat from returning directly to space resulting in a warmer planet.

Climate change, which has resulted in changes in weather patterns and growing seasons around the world, is a direct result of global warming. The warming weather can generate extreme weather conditions, such as drought and fires in some areas, more frequent and stronger hurricanes in other areas, tornadoes, flooding and other extreme weather-related events across the globe. The changing weather patterns can also result in adverse changes to our ecosystem. For example, milder winters can allow insects to survive in greater numbers in some areas and/or to emerge earlier in the spring putting additional pressure on trees and plants that can lead to die-off in some instances. As another example, warmer air and ocean temperatures can cause coral bleaching where corals lose their color and die potentially wiping out whole ecosystems that depend on the reefs for food and shelter. Thus, it is imperative that humans reduce, or even reverse, their impact on global warming by reducing their carbon footprint.

Traditional farming techniques have a large impact on our overall carbon footprint. According to some studies, agriculture is the second-leading source of carbon dioxide (CO₂) emissions. For example, traditional farming relies on nitrogen fertilizers produced from manufacturing processes that generate a significant source of greenhouse gases. Crops typically use up only a portion of the nitrogen from fertilizers with the remainder getting broken down by microbes in the soil or getting run off into waterways. Additionally, most vegetable and fruit crops grown by traditional agriculture methods are far away from the ultimate location where they will be consumed. Not only does this require that the crops be trucked long distances, thus burning a lot of gas in the process, it can also require harvesting crops before they are actually ripe based on an estimated time to delivery lest crops be overly ripe and spoiled upon arrival. These and other factors combine to result in an undesirably high percentage of vegetables and fruit being not suitable for sale and being thrown out.

Various efforts have been made to improve upon traditional farming techniques. For example, some companies are growing fruits and vegetables locally, close to or within major population centers, using hydroponics and indoor vertical farming techniques. While these solutions may solve the transportation problem and reduce the amount of fertilizer required, many known existing controlled-environment vertical farming presents a number of challenges that impact the ability of such vertical farming techniques have inherent limitations that have thwarted their adoption on a larger scale. For example, some previously known vertical farming techniques suffer from one or more of high energy consumption, high capital equipment costs, unfavorable unit economics, poor space utilization and/or poor pathogen containment any or all of which can increase the cost of crops grown with vertical farming techniques.

Accordingly, new and improved methods and techniques for indoor vertical farming are desirable.

### BRIEF SUMMARY OF THE INVENTION

Embodiments described herein pertain to a system and method for growing plants vertically within a controlled indoor environment. Some embodiments pertain to an integrated module (generally referred to herein as a “grow module”) that arranges plants radially around a central column such that the root mass of the plants is exposed and visible at the outer edges of the module and the plants grow inwards towards the central column. The central column can house radially mounted lighting needed by the plants during their growth cycle. Nutrient-rich water can be delivered by the system to the root mass according to growth schedules appropriate for the type of plants being grown, and a flow of temperature-controlled air can be directed into the grow module enabling a precise control of the environmental conditions that the radially arranged plants are exposed to during their growth cycle.

In some embodiments, various sensors and cameras that can mounted to the central column and/or at other locations within the grow module to monitor plants throughout their growth and to enable the system to adjust environmental conditions within the grow module when appropriate or desired. As described, embodiments enable an indoor agricultural facility to grow high-quality fruits, vegetables and/or other food in a sustainable, relatively low-cost manner.

According to some embodiments, a vertically-oriented module for growing plants is disclosed where the module comprises: a base comprising a housing for one or more auxiliary systems that support the module; a silo positioned on top of the base, the silo comprising a central core; an outer frame surrounding the central core, the outer frame defining a plurality of columns arranged radially around the central core, wherein each column is configured to receive one or more removable panels of plants; and a plurality of lighting units coupled to and arranged radially around the central core such that each lighting unit projects light away from the central core towards a corresponding column in the outer frame.

In some embodiments, a vertically-oriented module for growing plants comprises: a base comprising a housing for one or more of air handling components, irrigation piping and electronics for the module; a silo positioned on top of the base, the silo comprising a central core; an outer frame surrounding the central core, the outer frame defining a plurality of columns arranged radially around the central core; a plurality of panel receiving slots arranged along a height of each column in the plurality of columns, wherein each panel receiving slot is configured to removably receive a panel comprising a two-dimensional array of planting substrates positioned within a rectangular panel frame; and a plurality of lighting units coupled to and arranged radially around the central core such that each lighting unit in the plurality of lighting units is spaced directly opposite a unique one of the plurality of columns defined by the outer frame and projects light away from the central core towards a corresponding column in the outer frame.

In various implementations, the growth module can also include one or more of the following additional features and/or components. The one or more auxiliary systems housed in the base can include air handling components, irrigation piping, and/or electronics for the module. Each lighting unit in the plurality of lighting units can be spaced directly opposite a unique one of the plurality of columns defined by the outer frame. Each lighting unit can include a plurality of lighting elements arranged along a height of the central core. Each lighting unit can include a plurality of elongated LED bulbs including a first subset of one or more LED bulbs arranged in a central region along a height of the central core and a second subset of LED bulbs that includes a first LED bulb disposed between a bottom of the central core and the first subset of LED bulbs and a second LED bulb disposed between a top of the central core and the first subset of LED bulbs. Each of the one or more LED bulbs in the first subset of LED bulbs can include a plurality of symmetrically arranged LEDs, and each of the LED bulbs in the second subset of LED bulbs can include a plurality of asymmetrically arranged LEDs. The air handling components can include an air control unit to distribute temperature-controlled air to the module. The outer frame can define a plurality of panel receiving slots arranged vertically within each of the plurality of columns from a bottom of the silo to a top of the silo. Each panel receiving slot can be configured to removably receive a panel comprising an array of plants.

In various implementations, the growth module can also include one or more of the following. The module can further include a plurality of sets of nozzles spaced apart at even intervals along a height of the central core. Each of the sets of nozzles can include a plurality of individual nozzles configured to direct a flow of air from the air control unit towards the outer frame. The module can further include an adjustable air vent at a top of the silo that can be moved between opened and closed positions to adjust a pressure level within the silo. The module can further include a plurality of air ducts arranged between the base and the silo to allow air flow from the air handling components into the silo. The module can further include, at each panel receiving slot, a hinge element positioned adjacent a lower edge of the panel receiving slot and a latch element positioned adjacent an upper edge of the panel receiving slot. The module can further include a motor operatively coupled to rotate the silo above the base.

In some embodiments, the growth module can further include an irrigation system. The irrigation system can have: a primary conduit configured to be fluidly coupled to a pump house and extending within the central core to a top portion of the silo, a plurality of secondary arteries fluidly coupled to the primary conduit at the top portion of the silo, a plurality of veins fluidly coupled to each of the secondary arteries at different locations along the height of the silo frame, and a plurality of drippers fluidly coupled to each of the plurality of veins. Each of the plurality of secondary arteries can extend radially away from the primary conduit in different directions along the top of the silo and down at least a portion of a height of the silo frame. Each of drippers can be disposed directly adjacent to a top row of planting substrates in a grow panel. The irrigation system can be configured to allow water introduced by the drippers to cascade down from the top row of the array to each successive row before being recaptured and delivered through piping of the irrigation system to a wastewater tank.

In some embodiments, the growth module can further include a plurality of grow panels that include one or more of the following features. Each grow panel can be sized and shaped to be inserted within and removably coupled to one of the plurality of panel receiving slots. Each grow panel can be configured to support a two-dimensional array of plants within its corresponding panel receiving slot such that a root mass of the plants faces outward away from the outer frame and a stem and leaves of the plants extend within the silo and face inward towards the central core. Each grow panel can include a rectangular frame and an array of planting substrates disposed within the frame and is configured to rotate the array of planting substrates within its frame between a first position and a second position, where in the first position, the array of planting substrates is aligned to allow plants to grow perpendicularly away from the grow panel frame, and in the second position, the array of planting substrates is aligned to allow plants to grow away from the frame at an angle of between 20-70 degrees. Each grow panel can include a plurality of troughs within its frame. Each trough can support the plant substrates within one row of the array of planting substrates, and the plurality of troughs can include openings and tongues that direct water received at the trough to plant substrates directly beneath each trough. The tongues in a given row of a troughs can be bent downwards towards the plant substrates in the row beneath the given row such that the tongues help secure the plant substrates in the grow panel when the plant substrates are in the second position.

To better understand the nature and advantages of the present invention, reference should be made to the following description and the accompanying figures. It is to be understood, however, that each of the figures is provided for the purpose of illustration only and is not intended as a definition of the limits of the scope of the present invention. Also, as a general rule, and unless it is evident to the contrary from the description, where elements in different figures use the same reference numbers, the elements are generally either identical or at least similar in function or purpose.

### BRIEF DESCRIPTION OF THE DRAWINGS

FIG. 1 is a simplified perspective view illustration of a grow module according to some embodiments disclosed herein;

FIG. 2A is a simplified front plan view of the grow module shown in FIG. 1 according to some embodiments;

FIG. 2B is a simplified top plan view of the grow module shown in FIG. 1 according to some embodiments;

FIG. 3 is a simplified perspective view illustration of the grow module shown in FIG. 1 with grow panels according to some embodiments installed in the module;

FIG. 4A is a simplified front plan view of a light core according to some embodiments disclosed herein;

FIG. 4B is a simplified schematic view of an illumination pattern that can be generated by a light core according to some embodiments;

FIG. 4C is a simplified schematic view depicting a portion of the illumination pattern shown in FIG. 4B as it illuminates plants within a grow module according to some embodiments;

FIG. 4D is a simplified illustration of a single column of LEDs within a light core according to some embodiments;

FIG. 5A is a simplified drawing depicting air flow through of a grow module according to some embodiments;

FIG. 5B is a simplified drawing depicting air flow through of a grow module according to additional embodiments;

FIG. 5C is a simplified top view of air vents located at the top surface of a grow module according to some embodiments disclosed herein;

FIG. 5D is a simplified top view of an air vent cover according to some embodiments disclosed herein;

FIGS. 6A-6C are simplified top views of the air vent cover shown in FIG. 5C set to different positions over the air vents shown in FIG. 5B;

FIGS. 7A and 7B are simplified top view illustrations of grow panels according to some embodiments disclosed herein;

FIG. 8 is a simplified perspective view illustration of a grow panel according to some embodiments;

FIG. 9 is a simplified perspective view illustration of the grow panel shown in FIG. 8 positioned to be installed within a grow module according to some embodiments;

FIG. 10A is a simplified side plan view illustration of plants within a grow panel according to some embodiments positioned horizontally;

FIG. 10B is a simplified side plan view illustration of the grow panel shown in FIG. 10A aligned vertically with the plants in a first position perpendicular a central axis of a grow module according to some embodiments;

FIG. 10C is a simplified side plan view illustration of the grow panel shown in FIG. 10B with the plants rotated into a second position such that the plants are angled upward with respect to the central axis of a grow module according to some embodiments;

FIG. 11A is a simplified top schematic view of an irrigation system or a grow module according to some embodiments;

FIG. 11B is a simplified perspective view of a portion of the irrigation system shown in FIG. 11A;

FIG. 11C is an expanded view of a portion of FIG. 11B;

FIG. 12 is a simplified side plan view of a portion of the irrigation system shown in FIG. 11;

FIG. 13 is a simplified diagram illustrating a flow of water from the irrigation system depicted in FIGS. 11 and 12 through a grow panel installed in a grow module according to some embodiments;

FIG. 14 is a simplified schematic illustration of a portion of an agricultural facility having multiple grow modules according to some embodiments installed therein;

FIG. 15 is a simplified diagram of a spray irrigation system according to some embodiments;

FIG. 16A is a simplified top perspective view of the spray irrigation system shown in FIG. 15 arranged to irrigate four separate grow modules according to some embodiments; and

FIG. 16B is a top plan view of the spray irrigation system and grow modules depicted in FIG. 16A according to some embodiments;

### DETAILED DESCRIPTION OF THE INVENTION

The following description of embodiments of the invention is not intended to limit the invention to the specific embodiments discussed below, but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

Embodiments described herein pertain to a system and method for growing plants vertically within a controlled indoor environment. Described embodiments pertain to an integrated grow module that arranges plants radially around a central column such that the root mass of the plants is exposed and visible at the outer edges of the module and the plants grow inwards towards the central column. LED or similar lighting can be arranged along the central core to provide light needed by the plants for growth, and the system can include an irrigation system to deliver nutrient-rich water to the root mass according to growth schedules appropriate for the type of plants being grown.

In some embodiments, the system can include a distributed heating and cooling system that can direct a flow of temperature-controlled air into the grow module enabling a precise control of the environmental conditions that the radially arranged plants are exposed to during their growth cycle while reducing or eliminating vertical temperature gradients within the grow module. Embodiments can also include cameras and sensors mounted on the central core or other portions of the grow module to enable embodiments to monitor and adjust growth conditions when appropriate or desired. The described embodiments enable a controlled environment agricultural facility to grow high-quality fruits, vegetables and/or other food in a sustainable, relatively low-cost manner.

In an indoor agricultural facility with dozens or hundreds or more grow modules, environmental conditions within the volume within each grow module where the plants live (the grow environment) can be controlled independent of the grow environments within other grow modules and somewhat independent of the ambient environment within the agricultural facility itself. In this manner, the distributed heating and cooling system employed by some embodiments can advantageously reduce the heating and cooling requirements that might otherwise be required of a facility level HVAC systems while providing an ideal grow environment for plants within each grow modules that can be difficult if not impossible to obtain in larger controlled environment agricultural facilities where the environment for all plants is controlled by a facility level HVAC system.

### Example Grow Module

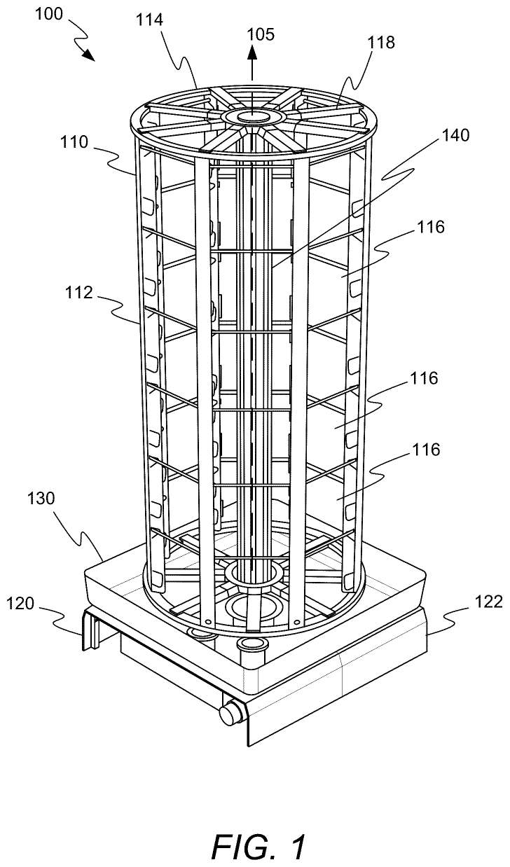

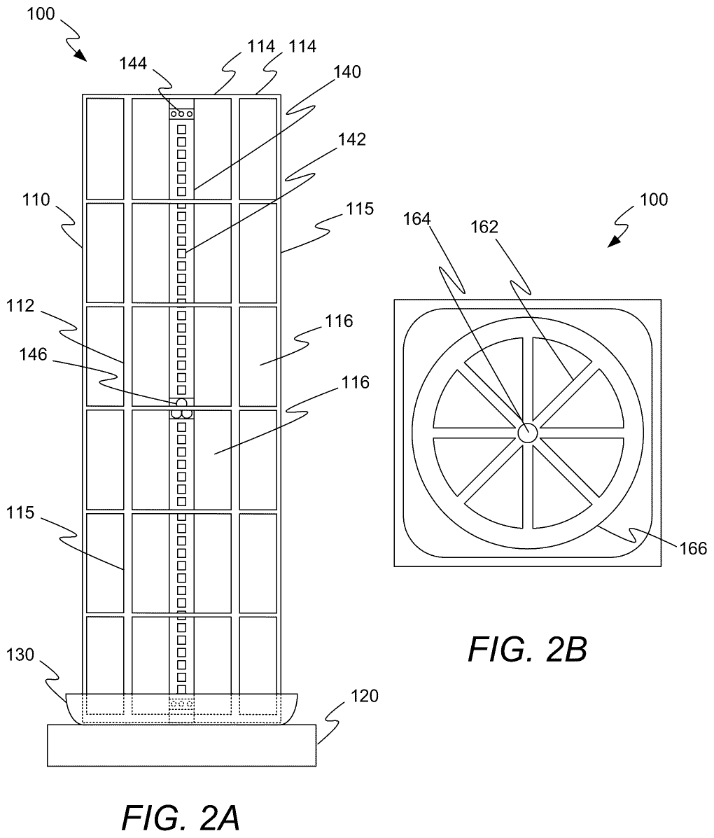

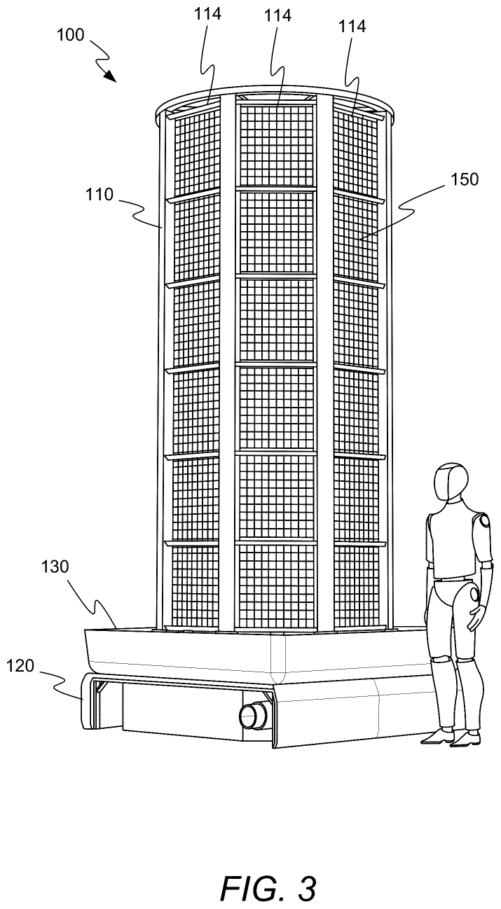

In order to better understand and appreciate embodiments, reference is first made to FIGS. 1, 2A and 3B where FIG. 1 is a simplified perspective view illustration of a grow module 100 according to some embodiments, FIG. 2A is a simplified front plan view of grow module 100, FIG. 2B is a simplified top plan view of grow module 100, and FIG. 3 is a simplified perspective view illustration of grow module 100.

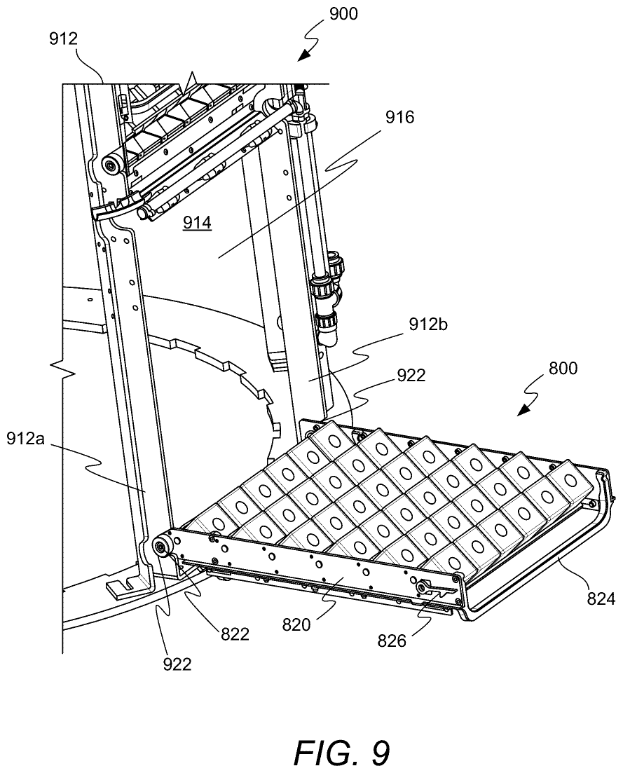

As shown, grow module 100 includes a silo 110 that sits on top of a base 120 within a tub 130. Silo 110 includes a frame 112 that arranges plants radially around a central axis 105. In doing such, frame 112 can include multiple posts 115 arranged radially around an inner, central core 140 and spaced apart from each other at even intervals. The posts 115 define multiple columns 114, and each column can include multiple slots 116 (sometimes referred to herein as “panel receiving slots”) arranged vertically along the height of the column. Each panel receiving slot 116 is configured to receive a removable panel of plants as described below with respect to FIG. 3. The spacing between adjacent posts 115 defines the width of the columns (and thus the width of the panel receiving slots). The height of the panel receiving slots can be defined by spacing between sets of features (described below with respect to FIG. 9) that allow the panels of plants to be removably attached to frame 112. In some embodiments, frame 112 can be made from a metal such as steel, aluminum or the like, but in other embodiments it can be made from an appropriately rigid and strong plastic, composite material or other suitable material.

The number of columns and the number of slots can vary and are implementation specific. In the depicted embodiment, frame 112 includes eight columns 114 with each column having six panel receiving slots 116. Since the columns surround central core 140, they combine to form an enclosed shape, which becomes an enclosed growing area when the slots are filled with panels of plants. With eight columns 114, frame 112 essentially has an octagonal cross-section when viewed from the top. A silo with six columns will have a hexagonal cross-section, a silo with nine columns a nonagon cross-section, etc. In some embodiments, frame 112 defines between five and twelve columns that surround central core 140.

Frame 112 (and thus each column 114) extends vertically from base 120 to a top end of silo 110 to define a height of silo 110. In some embodiments, the frame is between 6-18 feet tall, but embodiments are not limited to any particular height and the actual height of a grow module can depend on the height of the ceiling and/or needs of the indoor farming facility the grow module is installed within.

In some embodiments, frame 112 can also support an irrigation system (not shown in FIG. 1) that provides nutriated water to the roots of plants grown by the system, and grow module 100 can include air handling components, such as a distributed heating and cooling system (e.g., an HVAC unit, also not shown in FIG. 1) that generates and distributes temperature-controlled air to create a tightly controlled environment within silo 110.

Central core 140 is positioned within the center of frame 112 and aligned vertically along axis 105. The central core can have a height that is essentially equal to that of the frame and can support multiple units of radially mounted elongated lighting units 142 (e.g., LED or similar lighting) that face outward towards frame 112 to provide the energy (i.e., artificial sun light) needed by the plants for growth. Core 140 can also support various sensors 144 and cameras 146 that can monitor plants throughout their growth cycle. To provide additional structure for silo 110, frame 112 can be coupled to or integrally formed with central core 140 by a support 118 at the top and/or bottom of the frame. As shown in FIG. 2B, support 118 can include multiple spokes 162 that extend radially outward from central hub 164 that can be directly attached to central core 140. A distal end of each spoke 162 can be connected to an outer rim 166. A person of skill in the art will recognize that support 118 is just one example of a structure that can provide additional rigidity and support between frame 112 and central core 140 and that other structures can be designed to provide effective support.

Base 120 includes a housing 122 for air handling components and ducts, irrigation piping, pumps, electronics (e.g., onboard computers to read sensors and control the timing of lights, irrigation, etc.), a power supply and other components of grow module 100 needed to supply nutriated water, temperature-controlled air and grow lighting that enable the plants to grow and mature within an indoor facility. In some embodiments, some or all of the various components housed within base 120 can include appropriate input connections and/or output connections that link the components to larger systems within an agricultural facility. For example, nutriated water can be stored in a large holding tank and connected at an inlet of base 120 to irrigation piping for grow module 100. Similarly, tub 130 can collect and funnel any excess water not recaptured by the irrigation system to a drain that routes the water through appropriate piping within base 120 via an outlet to a wastewater sump tank and/or waster water recycler which can filter and sanitize the wastewater from multiple grow modules so it can be returned to and reused by each system 100. Tub 130 can also collect and contain solid material that is dropped or cut from the plants (e.g., leaves, flowers, etc.) so that the material can be more easily collected and disposed of without cluttering the agricultural facility.

FIG. 3 is a simplified perspective view illustration of grow module 100 with grow panels 150 installed in the columns 114 of frame 112. With panels 150 installed, silo 110 can create an enclosed cylinder-like volume (sometimes referred to herein as a “grow environment”) defined by walls of the plants in the grow panels within each of the columns 114. As discussed below, the enclosed space created by the columns of panels 150 enables grow module 100 to tightly control the environmental conditions that each plant is grown in. Additionally, in an indoor agricultural facility that includes more than one grow module 100, the environmental conditions within each separate grow module can be controlled independent of the other grow modules.

To enable plants to be placed within grow module 100 or take plants out of the grow module, each grow panel 150 can be removably installed in one of the panel receiving slots 116. In some embodiments, each panel receiving slot 116 includes a hinge element positioned adjacent to or along a lower edge of the slot and a latch end spaced apart from and opposite the hinge end and thus positioned adjacent to or along an upper edge of the slot. A first end of the grow panel 150 can then be inserted in the panel receiving slot such that a bearing or similar structure on the grow panel mates with the hinge end. When mated as such, the grow panel is hinged to the column that panel receiving slot 116 is positioned within. The panel insertion step can be done, for example, with the grow panel in a horizontal or slightly angled position. The panel can then be rotated around the hinge end up to a vertical position where a second end of the grow panel, opposite the first end, can be secured by a latch or similar structure at the latch end of panel receiving slot 116. Details of one particular embodiment of a hinge end and latch end of a panel receiving slot and a corresponding grow panel is discussed with respect to FIG. 9. A person of skill in the art will readily recognize other attachment mechanisms and structures that can be incorporated into panel receiving slots and grow panels in other embodiments. Accordingly, embodiments are not limited to the particular hinge and latch mechanisms presented herein as examples.

The grow panels can hold arrays of plants such that the plants grow inward towards inner core 140 and the root mass of the plants faces outward away from the central core. In the embodiment depicted in FIG. 3, each grow panel 150 includes a 10×10 array of plants for a total of 100 plants. Since frame 112 defines eight vertically-oriented columns 114 with each of the individual columns 116 holding six separate grow panels, as depicted, grow module can house 4,800 plants. It is to be understood, however, that embodiments are not limited to the particular number of columns 114 or panel receiving slots 116 depicted in the FIGS. In other embodiments, silo 110 can include fewer than or more than eight columns and each column can include fewer than or more than six slots for grow panels. Additionally, embodiments are not limited to grow panels of any particular size and other embodiments allow for larger or smaller grow panels as well as grow panels that have plants spaced further apart to allow for lower density arrangements of larger plants or grow panels that have plants spaced closer together for higher density arrangements smaller plants than what is shown in FIG. 3.

### Lighting

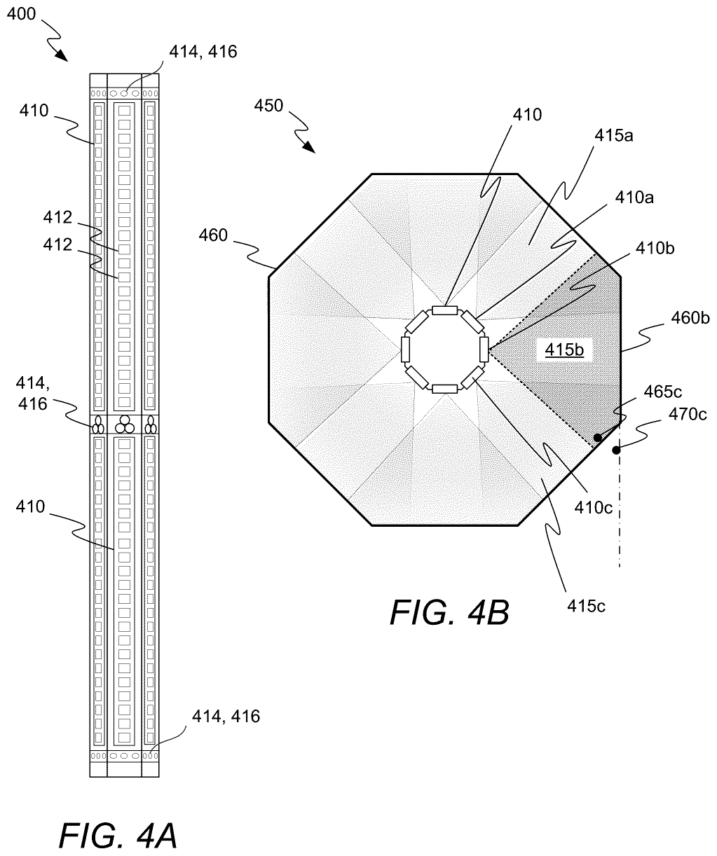

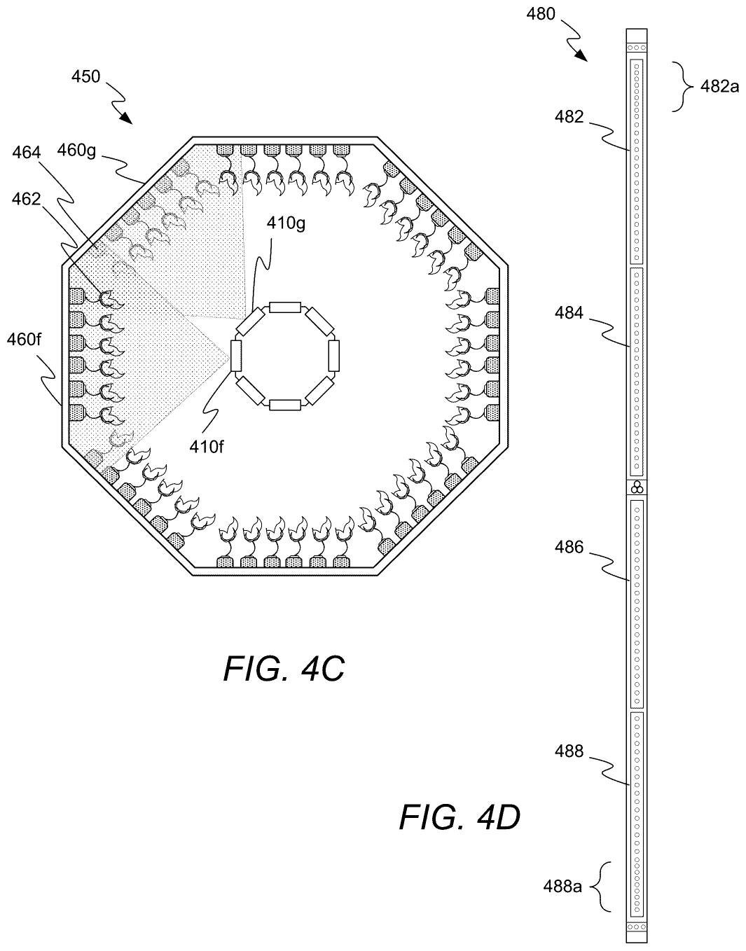

FIG. 4A is a simplified front plan view of a central core 400 according to some embodiments. Central core 400 can be representative of central core 140 shown in FIGS. 1 and 2A and is sometimes referred to herein as “light core 400”. As shown, central core 400 includes a multiple lighting units 410 radially arranged around core 400 and extending along a majority of a height of the core. In some embodiments, the lighting units can be arranged such that each individual lighting unit 410 directly faces a corresponding column in the silo as illustrated in FIGS. 4B and 4C. In the depicted embodiment, each lighting unit 410 includes multiple lighting elements arranged along a height of the central core. The lighting elements can be elongated strips of LED lighting where each strip of LED lighting includes an array of individual LEDs 412. A person of skill in the art will recognize that other types of lighting elements and other arrangements of individual LEDs or lights within each lighting unit are possible.

In some embodiments, such as depicted in FIG. 4A, the LED lighting strips in lighting unit 410 can include symmetrical one-dimensional arrays of LEDs 412 (e.g., twenty-two LEDs aligned in a single row). FIG. 4A is for illustrative purposes only, however, and LEDs can be arranged in a two-dimensional array or, as discussed below, arranged asymmetrically in order to ensure an even distribution of light projected from the LED column along the entire length of the light core.

Central core 400 can include various sensors 414 and cameras 416 that enable the grow module to monitor plant health and growing conditions. Non-limiting examples of sensors that can be included in sensors 414 include: sensors that monitor air temperature, air speed, carbon dioxide levels, oxygen levels, relative humidity and light level among others. Data from the sensors can be collected, analyzed and used, in conjunction with the automated features of a grow module, to ensure that individual plants receive optimal levels of light, air flow and nutrients.

Arranging the plants in a grow module such that they face inward towards light core 400 and surround the light core enables less energy to be used to provide the plants with light levels optimized for plant growth as compared to more traditional vertical farming techniques that typically arrange plants linearly within an agricultural facility. To illustrate, reference is made to FIG. 4B, which is a simplified schematic top view of a grow module 450 that includes a central light core 400 centered within a silo 460. Grow module 100 discussed above can be representative of grow module 450, and thus silo 110 can be representative of silo 460. For case of illustration, grow module 450 is shown without any plants.

As shown in FIG. 4B, a light core 400 includes eight columns of lighting units 410 with each lighting unit positioned opposite a corresponding column of silo 460. Light projected from each lighting unit 410 is depicted as (in the planar view of FIG. 4B) a cone that encompasses the entirety of the column of silo 460 opposite each lighting unit 410 and also overlaps some with the cones from adjacent lighting units. For example, as shown, lighting unit 410b projects a light cone 415b towards column 460b of the silo that overlaps with light cones 415a and 415c projected from adjacent lighting units 410a and 410c, respectively. The enclosed shape of silo 460 results in a greater amount of light energy reaching plants in the overlapping areas than if the plants were arranged linearly. That is, a plant at location 465c receives more light energy from light cone 415b than if the plant was in a traditional linear arrangement putting it at a location 470c. In some embodiments, the enclosed nature of silo 460 enables a reduction of between 15-20% in lighting energy to be achieved.

To further illustrate the overlap enabled by embodiments, reference is made to FIG. 4C, which is a simplified schematic view depicting the overlap between two adjacent lighting units 410f, 410g in the a portion of the illumination pattern shown in FIG. 4B as it illuminates plants within a grow module according to some embodiments. As shown, a first set of plants is growing in column 460f, and a second set of plants is growing in column 460g. The end plants 462, 464 in each column receive overlapping light from the two lighting units. Since plant 464 is angled towards lighting unit 410f, the amount of light energy it receives from lighting unit 410f is more than it would otherwise receive if aligned parallel with the plants in column 460f. Similarly, since plant 462 is angled towards lighting unit 410g, the amount of light energy it receives from lighting unit 410g is more than it would otherwise receive if aligned parallel with the plants in column 460g.

FIGS. 4B and 4C illustrates light projected from each lighting unit in the X and Y axes. While not shown in FIGS. 4B or 4C, the individual LEDs can project cones of light that overlap with each other along the Z axis as well. Since there is less overlap between LEDs at the top and bottom edges of silo, some embodiments arrange the individual LEDs asymmetrically along a length of light core 400 such that there is a greater distribution of LEDs at the top end and bottom end of light core 400.

FIG. 4D is a simplified illustration of a single lighting unit 480 according to one such implementation that can be representative of each of the lighting units 410 of light core 400 according to some embodiments. As shown in FIG. 4D, lighting unit 480 includes four different LED lighting strips 482, 484, 486 and 488 where each strip can, for example, be considered a separate LED bulb. Lighting strips 484, 486 are centrally located along the height of column 480 and have individual LEDs arranged symmetrically along a length of each strip. Lighting strips 482 and 488 have an increased density of LEDs in regions 482a and 488a at the outer end of each strip near the top and bottom, respectively, of column 480. The spacing of individual LEDS in regions 482a, 488a can be selected to provide a uniform distribution of light along the entire length of column 480 so that plants at the top and bottom portions of the grow core are exposed to lighting conditions that are substantially similar to plants within the middle region of the grow core.

### Air Handling

Grow modules according to some embodiments include air handling equipment and input air controls that enable the modules to inject streams of air and/or specific beneficial gases into the growing environment at a specific controlled temperature. Stagnant air creates an environment for fungal and bacterial disease growth, reduced transpiration and water uptake, and reduced growth rate. Thus, plants generally do better with some amount of air flow. The air input controls can inject filtered air into the grow environment of silo 110 to creating both a flow of air across the plants and a positive pressure within the grow environment, which can reduce or eliminate cross-contamination between different grow modules making it difficult for pests and pathogens to spread from one grow module to another. Thus, even if one grow module in a large indoor agricultural facility becomes infected with pests or pathogens, other grow modules in the facility can remain disease free and healthy.

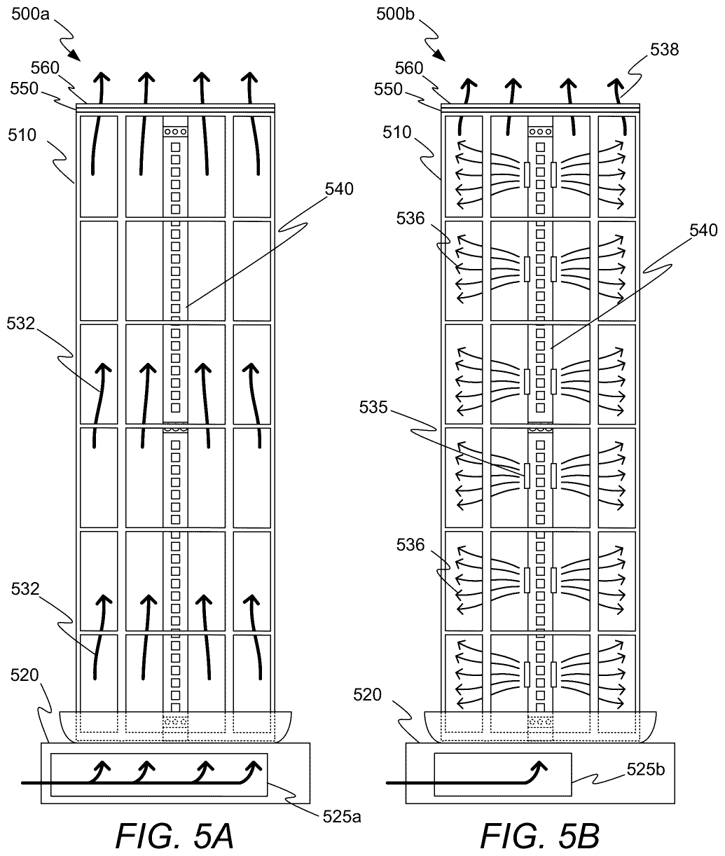

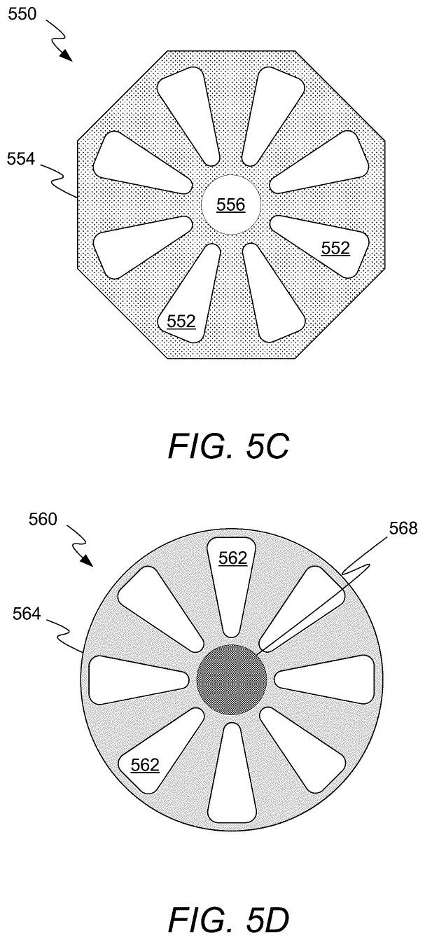

FIGS. 5A and 5B are simplified drawings depicting air flow through two different grow module 500a, 500b, respectively, according to embodiments disclosed herein. Each of the grow modules 500a, 500b includes a silo 510, a base 520 and a central core 540 that can be similar to silo 110, base 120 and central core 540 discussed above. Base 520 can include air flow and climate control unit (e.g., 525a, 525b), such as an HVAC unit, which can inject a flow of temperature-controlled air through silo 510. An air vent 530 can be located at a top surface of silo 510 and an air vent cover 540 can be positioned over the air vent and can be opened or closed to control ventilation and environment within the silo. When opened, vent cover 540 allows air directed into silo 510 to flow through the grow environment and out the top of the silo through air vent 530.

The temperature and flow rate of the air can be continuously monitored by sensors discussed above enabling each grow module 510a, 510b to adjust the temperature and/or flow rate as desired to maintain a precise temperature and humidity of within the grow environment that has been determined to be ideal for the particular type of plants grown within silo 510. Additionally, the air flow rate and vent cover position can be adjusted as discussed below to create a desired positive pressure within the grow environment. The combination of the enclosed space provided by the frame with precise environmental control allows temp within the grow environment of each of grow modules 500a, 500b to be set independent of others within a very tight tolerance (e.g., plus/minus 1-3 degrees). Such precise control over the grow environment can provide a noticeable advantage compared to some previously known vertical farming systems that have long racks of plants extending horizontally and aligned vertically in an indoor environment that can have large temperature gradients from top to bottom and allow for the easy spread of pests or pathogens among plants within the facility.

Referring now to FIG. 5A, in some embodiments air flow through grow module 500a can be introduced through ducts located at the bottom of silo 510 by air flow control unit 525a and flow upwards through the grow environment as indicated by arrows 532. The air flow can then exit silo 510 through air vent 530.

In the embodiment depicted in FIG. 5B, central core 540 can include a gas conduit (not shown) along its length and multiple sets of nozzles 535 that are fluidly coupled to the gas conduit. The sets of nozzles 535 can be spaced at even intervals along the height of central core 540, and at each interval, each set of nozzles can include multiple nozzles radially positioned around core 540 to introduce gas evenly throughout the entire volume of the grow environment. As one example, in one particular implementation where a grow core has eight columns of LED lighting corresponding to eight columns of silo 510, multiple sets of nozzles 535 can be spaced at equally spaced intervals along a height of the grow core. Each set of nozzles 535 can then include eight individual nozzles positioned radially around the grow core such that each individual nozzle in the set of nozzles directs airflow towards one of the eight columns of silo 510. Flow control unit 525b can introduce gas into the gas conduit within central core 540. The gas can then be directed by nozzles 535 outward into the grow environment directly towards the plants as indicated by arrows 536 before exiting the grow module through air vents 550 at the top of silo 510 as indicated by arrows 538. Introducing temperature-controlled air at multiple locations throughout the height of the grow environment can reduce the tendency for temperature gradients to be formed between the top and bottom portions of silo 510.

FIGS. 5C and 5D are simplified top plan views of air vent 550 and air vent cover 560, respectively, according to some embodiments. As shown in FIG. 5C, air vent 550 includes multiple vent openings 552 formed through a solid plate 554. Vent openings 552 can be arranged radially around a central opening 556 formed through plate 554 and can be spaced apart from each other at even intervals. Plate 554 can sit on top of the frame portion of silo 510 and air that is introduced into the silo (e.g., from one of climate control units 525a, 525b) can pass through silo 510 and out the vent openings 552. Central opening 556 plate 554 to be fitted over central core 540.

The air vent cover 560 includes a solid plate 564 and multiple cover openings 562. Cover openings 552 can be arranged radially around a perimeter of solid plate 564 in a pattern that generally corresponds to the pattern of vent openings 552. The cover openings 562 can also be sized and shaped to match the size and shape of air vents 552. Sections 566 of the solid plate 564 are formed between adjacent cover openings and can be sized and shaped to be at least slightly larger than air vents 552 as described below.

Cover 560 can be rotatably coupled to a shaft (not shown) that extends through central core 540 and through opening 556 of air vent 550. The shaft can be coupled to plate 564 at one end and to a motor (not shown) at its opposite end. In some embodiments, the shaft can be directly coupled to solid plate 564 of the vent cover, but in the embodiment shown in FIG. 5D, the vent cover includes a cap 568 that is mechanically coupled between the shaft and solid plate 564 such that when the shaft rotates, cap 568 transfers the rotation to plate 564.

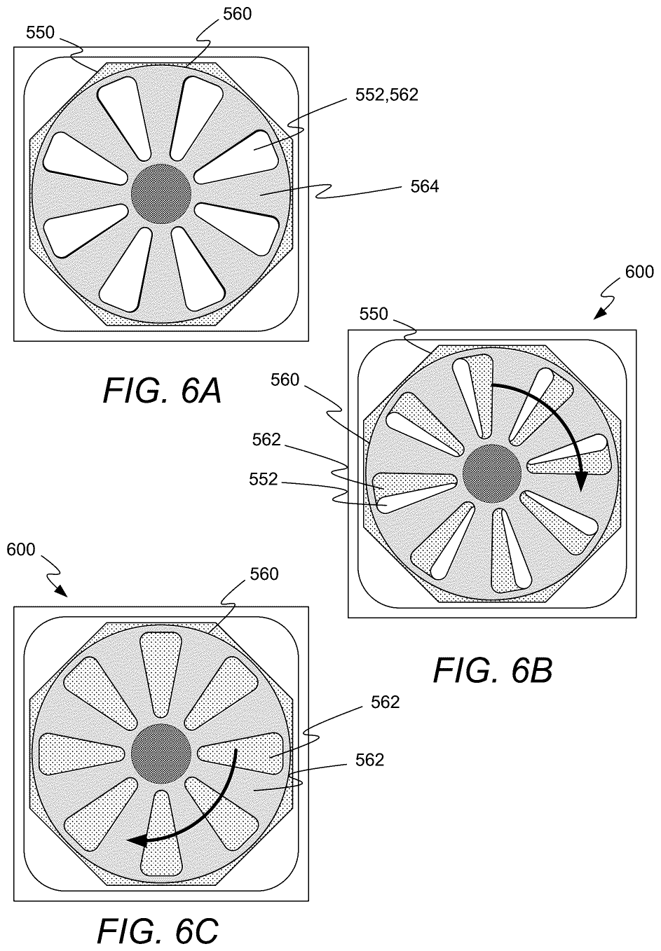

The motor can be controlled by an onboard computer within base 520 to rotate air vent cover 560 such that the relative positions of air vents 552 and cover vents 554 changes with the rotation. As noted above, cover openings 562 can be sized and shaped to match the size and shape of air vents 552 and sections 566 of the solid plate 564 formed between adjacent cover openings can be sized and shaped to be at least slightly larger than air vents 552. Thus, when vent cover 560 is rotated, vent openings 552 can go from being completely open to completely closed depending on the position in which vent cover 560 is rotated relative to air vent 550. To illustrate, reference is made to FIGS. 6A-6C, which are simplified top views of air vent cover 560 set to different positions over air vents 550.

FIG. 6A depicts vent cover 560 rotated into a first position such that cover openings 562 fully align with vent openings 552. In this first position, the vent cover does not impede air flow through silo 510 and air directed into the silo by air control unit 525a or 525b can exit the silo through the full width of each an air vent 552.

In FIG. 6B, vent cover 560 has been rotated approximately 10 degrees such that the cover openings 562 are partially aligned with vent openings 552 with portions 564 of the vent cover partially blocking each vent opening 552. Rotating vent cover 560 into a position that partially blocks the vent openings as shown in FIG. 6B allows air to escape through the top of silo 510 (e.g., as shown in FIGS. 5A and 5B) while enabling grow modules 500a, 500b to more easily increase the pressure within the grow environment. As discussed above, the increased pressure can help prevent pests and pathogens that may find their way into the agricultural facility from reaching and infecting plants within silo 510. FIG. 6C depicts the vent cover 560 rotated approximately 22.5 degrees into a position where air vents 552 are completely blocked by portions 556 of the vent such that air directed into silo 510 can only exit the grow environment through any gaps between grow panels.

### Grow Panels

As discussed above, embodiments allow for different densities of plantings in each grow panel depending on the type of crop grown on the panel. In some embodiments the grow panels can be interchangeable such that each grow panel can have essentially the same size frame to fit within any particular panel receiving slot of a grow module, but different panels can have different planting densities. Within each frame can be a plurality of plant cubes or substrates made from an appropriate planting material, such as rockwool, jiffy pots or jiffy plugs among others. The plant cubes can be sized differently to accommodate different densities of plantings with a grow panel. For example, in various embodiments individual grow panels within a grow module can contain an array of plant cubes sized for low density plantings (e.g., 100 mm square cubes) to allow for relatively large plants, medium density plantings (e.g., 40 mm square cubes) to allow for medium sized plants, or high density plantings (e.g., 25 mm square cubes) to allow for relatively small plants.

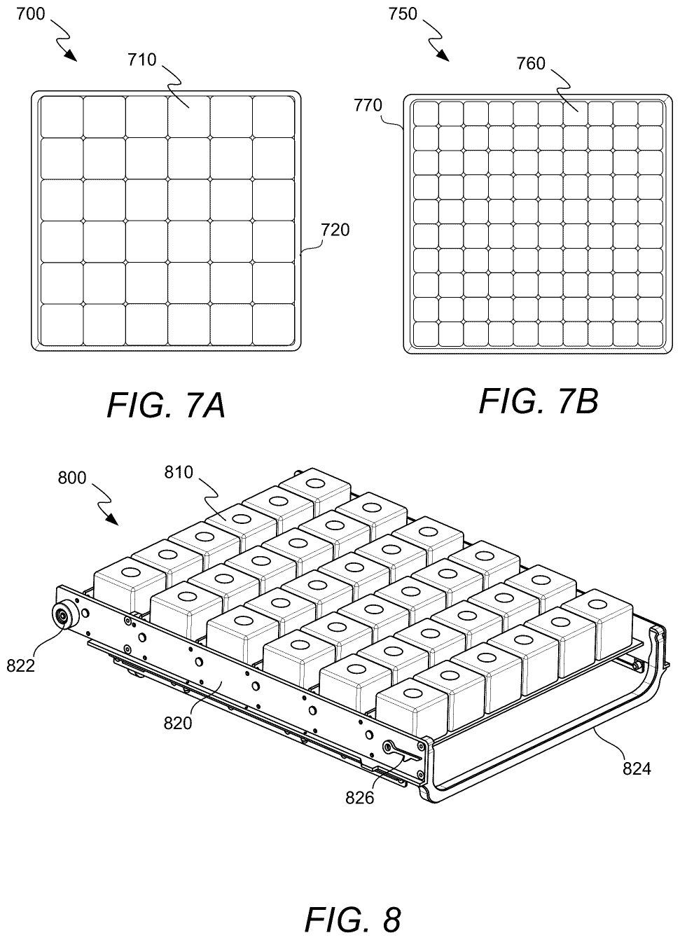

FIGS. 7A and 7B are simplified top view illustrations of grow panels 700 and 750, respectively, according to some embodiments. As depicted, grow panel 700 includes a 6×6 array of plant cubes 710 supported by a rectangular frame 720. Each plant cube 710 is essentially a pot or container in which a single plant (or a cluster of plants for certain types of plants) can be grown. Thus, with thirty-six plant cubes, grow panel 700 enables thirty-six plants to be grown in the panel. Grow panel 750 is a higher density panel that includes a 10×10 array of plant cubes 760 supported by a frame 770 enabling one hundred plants to be grown in panel 700. Frames 720 and 770 can have the same dimensions and structure so the two frames are interchangeable and either frame can be placed into a given plant receiving slot of a grow module.

FIG. 8 is a simplified top perspective view illustration of a grow panel 800 according to some embodiments. Panel 800 includes thirty-six plant cubes 810 arranged in a 6×6 array similar to grow panel 700. Each plant cube is shown with a small centrally located hole to indicate where the stem of a plant might protrude from the cube. The plant cubes themselves can be considered a substrate of growing material in which the roots of the plant embed themselves in and that holds moisture for the plants over its lifetime.

Plant cubes 810 are shown in FIG. 8 positioned within a frame 820 that is sized and shaped to fit within one of the columns of a grow module (e.g., one of panel receiving slots 116 in grow module 100). Panel frame 820 includes a pair of bearings 822 located on opposing sides at one end of the frame and a handle 824 on the end of the frame opposite the bearings. The bearings 822 protrude outward, away from a sidewall of frame 820. Panel frame 820 can also include a pair of latches 826 located on opposing sides of the frame adjacent to handle 824. Latches 826 can be used to secure the panel frame into an appropriately sized panel receiving slot as described below.

Reference is now made to FIG. 9, which is a simplified perspective view illustration of grow panel 800 shown in FIG. 8. As shown in FIG. 9, panel 800 is positioned to be installed within a panel receiving slot 916 of a grow module 900 of which only a portion is depicted. Grow module 900 can be similar to any of the grow modules discussed above including grow modules 100, 500a, 500b. Grow module 900 includes a frame 912 that defines multiple columns for receiving grow panels. In the portion of grow module 900 visible in FIG. 9, frame 912 includes two studs or posts 912a, 912b that define the vertical height of the column and that are spaced apart from each other to define a width of column 914 in the frame (and thus a width of plant receiving slot 916).

Grow panel 800 is sized and shaped to fit within plant receiving slot 916. As shown, frame bearings 822 of grow panel 800 have been inserted into (mated with) corresponding hinge elements 922 formed in posts 912a, 912b. In the depicted position, grow panel 800 can be rotated upwards (for example, by lifting with handle 824) with bearings 822 acting as a hinge for the grow panel. At the top of the rotation the grow bottom can be locked into panel receiving slot 916 by latches 826 formed on opposite sidewalls of panel frame 820 that can mate with locking components (now shown) on studs 912a, 912b.

In the embodiment shown in FIG. 9, hinge elements 922 are rounded cutouts or grooves formed in posts 912a, 912b that bearings 822 fit within. Embodiments are not limited to such, however, and in other embodiments hinge elements 922 and bearings 822 can be other appropriate structures that can, when mated, cooperate to form a hinge that joins the grow panel to the panel receiving slot. and allow the grow panel to rotate updates around an axis defined by the hinge. Similarly, embodiments are not limited to latches 826. In other embodiments, any appropriate structure that can secure grow panel 800 into the panel receiving slot 916 when the panel is rotated upwards into its vertical position can be employed, including other mechanical structures, magnetic couplings, straps and the like.

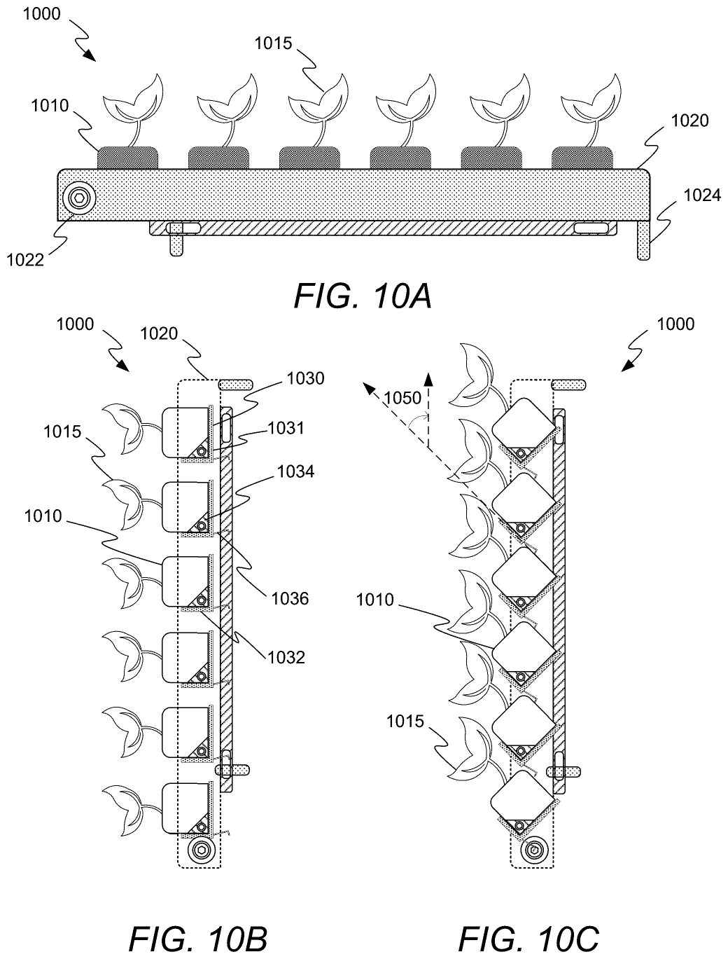

Plants are growing within a silo are aligned with the silo columns in a vertical orientation, but the plants generally prefer to grow at an angle, such as 45 degrees, rather than grow perpendicular to the silo columns. In order to improve productivity, in some embodiments, the same grow panels, such as grow panel 800, that are part of grow modules disclosed herein can also be used in other phases of the plant's life cycle. For example, grow panel 800 can be used to initially germinate seedlings before they are ready to be moved to a grow module and can also be sent through an automated transplant machine or harvester when the plants are ready to be moved into the farm for full growing or to harvest. In such stages, it can be important for the grow panels to be oriented in a flat, horizontal position with the plants growing upward, perpendicular to the grow panel frame. With that in mind, in some embodiments, grow panels are configured so that the rows of plant cubes within each panel can be moved between a first position in which plant cubes and plants extend perpendicularly away from the grow panel (e.g., an ideal position for when panels are placed flat on a germination rack and the ideal position for when the panels are placed flat and sent through an automatic harvester) and a second position in which the plant cubes and plants are angled upwards (e.g., at 45 degrees) when the panel is installed in a grow module. In the embodiment depicted in FIG. 9 and FIG. 10C, the second angle is 45 degrees as indicated in FIG. 10C by angle 1050. Embodiments are not limited to any particular angle for the second position, however, and in various embodiments in the second position plant cubes and plants can be angled at a fixed angle of between 20-70 degrees, between 30-60 degrees, between 35-55 degrees or between 40-50 degrees.

In some embodiments, each grow panel includes a mechanical linkage that is operatively coupled to each row of plant cubes and can be actuated to switch all the grow cubes in the panel at once between the first and second positions. The mechanical linkage can be manually controlled by, for example, pulling a lever, or can be electronically controlled and responsive to a user input (e.g., pushing a button). In still other embodiments, the linkage can be activated automatically to switch the plant cubes between the first and second positions when placed within or removed from a panel receiving slot. For example, the linkage can be operatively coupled to the mechanism that locks the grow panels into a panel receiving slot so that when a panel is initially rotated upwards within a plant receiving slot and locked into place, the linkage is actuated to switch the grow cubes to the second, angled position. Similarly, when a panel is unlocked and removed from a panel receiving slot the lock mechanism can actuate the linkage to switch the grow cubes from the second, angled position to the first position. A person of skill in the art will recognize that myriad of different mechanical mechanisms and linkages can be designed to swivel the grow cubes between the first and second positions as described.

In FIG. 9, grow panel 800 is shown with plant cubes in the second, angled position. FIG. 10A is a simplified side plan view illustration of a grow panel 1000 arranged in a horizontal flat position. As depicted, grow panel 1000 includes plant cubes 1010 populated with plants 1015. Grow panel 1000 also includes a frame 1020 having a bearing 1022 and a handle 1024 similar to bearing 822 and handle 824 discussed above. In FIG. 10A, the rows of grow cubes 1010 are arranged in the first position such that plants 1015 are growing vertically, as they would in a normal outdoor environment. As stated above, this horizontal flat arrangement of grow panel 1000 with plant cubes 1010 and plants 1015 extending perpendicularly away from the grow panel can be an ideal position for other stages of the plant's growth cycle including when the plants are initially seeded by a seeding machine, germinated within a germination chamber, or harvested by an automatic harvester.

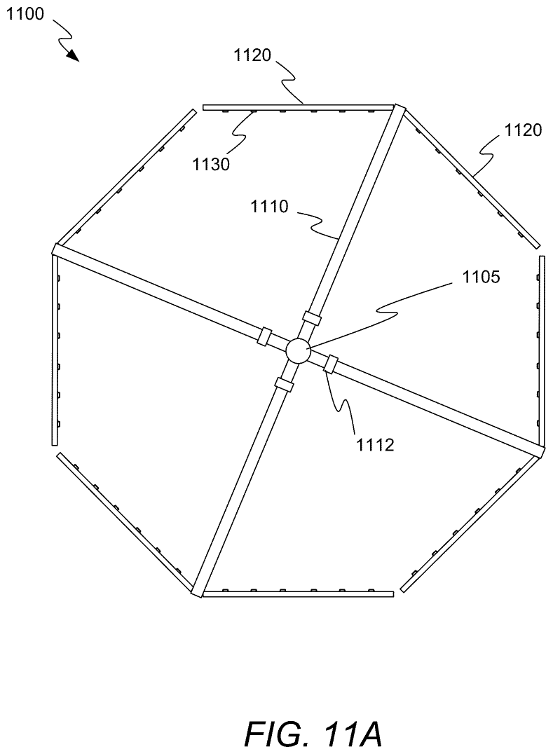

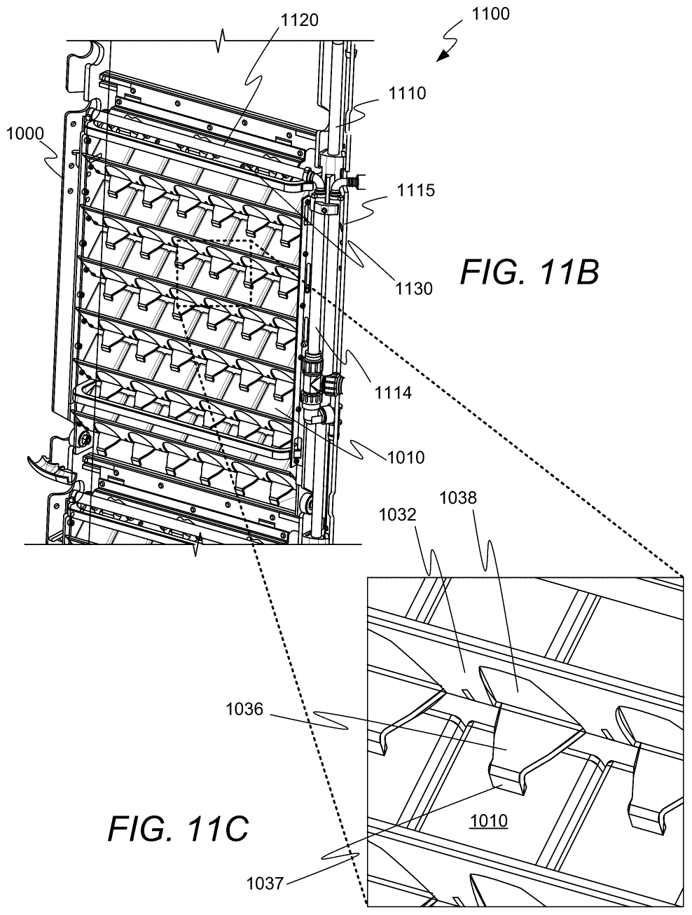

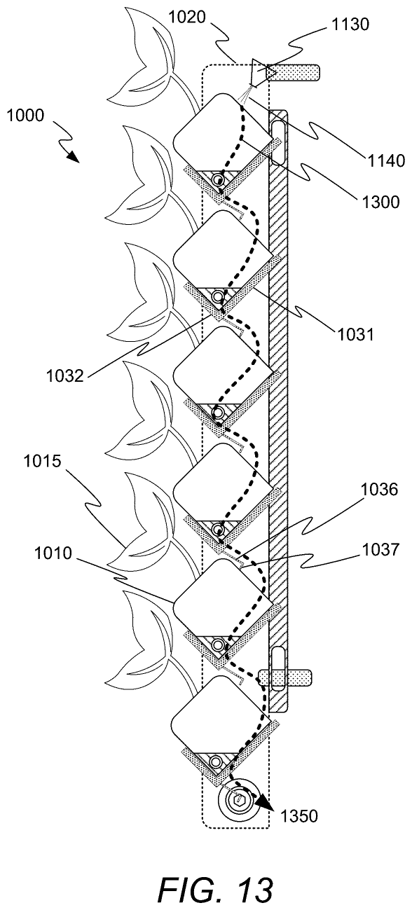

FIG. 10B is a simplified side cross-sectional view illustration of grow panel 1000 shown in FIG. 10A aligned vertically with the plant cubes 1010 in the first position perpendicular a central axis (e.g., axis 105 shown in FIG. 1) of a grow module. As a reference point, the outline of sidewalls of frame 1020 is shown in phantom dotted lines. Visible in FIG. 10B are troughs 1030, one for each row of plant cubes, which extend along the width of grow panel 1000. The troughs 1030 can have a back 1031 and a seat 1302 that connect with each other (e.g., at right angles) and provide surfaces that supports the grow cubes in both the first and second positions. In some embodiments, dividers 1034 can be positioned along the troughs between adjacent plant cubes to better secure the plant cubes within each row. The dividers 1034 can also function to isolate adjacent vertical water channels from each other as described below. Also shown in FIG. 10B are tongues 1036 that are aligned with openings 1038 (shown in FIG. 11C) to direct water that passes through the plants in a given row to the plants in the row immediately below as described in more detail with respect to FIG. 13.

While some embodiments can allow plants 1015 to remain in the position shown in FIG. 10A (the first position) in the grow environment as the plants mature, as previously stated, plants generally prefer to grow at an angle, such as 45 degrees. FIG. 10C is a simplified side cross-sectional view illustration of grow panel 1000 shown in FIG. 10B with the plant cubes 1010 swiveled to the second position such that the plant cubes 1010 and plants 1015 are angled upward at an angle 1020 with respect to the central axis of a grow module and towards the top of the grow module. In the particular embodiment depicted in FIG. 10C, angle 1050 is 45 degrees. When tilted such, trough back 1031 and trough seat 1032 form a trough that can funnel water that passes through a plant cube 1010 to openings 1038 and tongues 1036 which are themselves angled downwards in the second position.

### Irrigation

Plants grown within a grow module require water to grow. Towards this end, embodiments can include an irrigation system that delivers nutriated water directly to the root mass of each plant. In some embodiments, water can be supplied from a pump house to a central conduit that extends up through the central core of the growth module (e.g., core 140) to supply water to a system of arteries and veins that run down each column of the grow module. One such irrigation system is discussed below with respect to FIGS. 11A-11C, 12 and 13.

FIG. 11A is a simplified top plan view of an irrigation system 1100 for a grow module according to some embodiments. Irrigation system 1100 can be directly attached to the frame of a silo in an irrigation system, such as frame 112. For case of illustration, however, irrigation system 1100 is shown as a separate entity, not attached to a frame or to any other part of a grow module. Irrigation system 1100 includes a primary conduit that extends from a pump house for the grow module up through the central core of the growth module as indicated by conduit 1105. Multiple secondary arteries 1110 can be radially arranged around primary conduit 1105. For example, each secondary artery 1110 can extend along one of the spokes (e.g., spoke 162) of a top support (e.g., support 118) of a silo. While not shown in FIG. 11A, each secondary artery 1110 can include an elbow joint at or near the periphery of the silo that redirects the secondary artery 1110 down the length of the silo along a corresponding post of the silo frame.

Irrigation system 1100 can further include multiple pairs of veins 1120 that extend away from each secondary artery 1110 in generally opposite directions at regular intervals along the height of the silo. Drippers 1130 can be fluidly coupled to each vein 1120 to allow water to flow or drip out of the vein towards the plants below the drippers. The size and type of dripper can be selected to deliver a desired flow rate (e.g., two gallons per hour) to the plants. Since FIG. 11A is a top plan view, only a single pair of veins 1120 and corresponding drippers 1130 are shown for each secondary artery 1110. Some embodiments, however, include a separate veins and corresponding sets of drippers positioned at each panel receiving slot of the silo.

Each of the secondary arteries 1110 can be fluidly coupled to primary conduit 1005 by a valve 1112 that can be opened or closed under the control of an irrigation schedule executed by a computer or other processing unit. When the valves are opened, primary conduit 1105 can deliver nutriated water pumped from a tank or similar system into the secondary arteries 1110. The secondary arteries 1110 can, in turn, be fluidly coupled to a series of veins 1120 that extend away from the secondary arteries at each of the panel receiving locations within the frame, such that each vein serves as the source of nutriated water for all the plants arranged in a corresponding grow panel within the silo of the grow module.

The particular implementation of irrigation system 1100 depicted in FIG. 11A is designed for use with an eight-sided silo. The embodiment illustrated includes four separate secondary arteries 1110 radially arranged around the silo at 90-degree intervals from each other. Each of the secondary arteries 1110 has a pair of veins fluidly coupled to the artery at each level of the silo. As stated above, since FIG. 11A is a top plan view, only a single pair of veins 1120 and corresponding drippers 1130 are shown in FIG. 11A for each secondary artery 1110. In embodiments where the silo includes six levels or rows of plant receiving slots arranged from the bottom of the silo to the top (e.g., silo 110), irrigation system 1100 can include six pairs of veins fluidly coupled to each of the secondary arteries 1110, one pair for each level. A person of skill in the art will readily appreciate, based on the present disclosure, that irrigation systems for silos with fewer or more than eight columns and/or fewer or more than six levels can be designed with an appropriate number of secondary arteries and an appropriate number of veins as required by a particular silo.

FIG. 11B is a simplified perspective view of a portion of irrigation system 1100 according to some embodiments. For case of illustration, the portion of irrigation system 1100 shown in FIG. 11B is for a single grow panel 1000 (shown without plants) installed in a single panel receiving slot of a grow module according to some embodiments. It is understood that irrigation system 1100 can irrigate plants in each and every grow panel in the grow module in the same or similar manner as shown in FIG. 11B. Thus, additional conduits 1120 and additional sets of drippers 1130 can be similarly situated at the top row of each grow panels in the grow module.

As depicted in FIG. 11B, irrigation system secondary artery 1110 can travel down along one of the posts 1115 (e.g., one of posts 912a or 912b) of the grow module frame. Secondary artery can run for all or most of the length of post 1115 and similar arteries 1110 can be run along one of the posts of other columns of the grow module as indicated in FIG. 11A. Veins 1120 can extend above the top row of plant cubes in grow panel 1000. In some embodiments, rather than having a connection between secondary artery 1110 and veins 1120 directly at the level at which the veins branch off from the secondary artery, the connection is located at position below the veins requiring the secondary artery to have a first section that delivers fluid past the veins and a second section 1114 that brings the fluid back up to the veins (note the first section is not visible in FIG. 11B as it is located behind second section 1114). A u-joint (not visible in FIG. 11B) or similar structure can connect sections 1112 and 1114. This arrangement can help control drainage from the drippers such that, when water is shutoff to the irrigation system, some excess water can be held in sections 1112 and 1114 enabling a more precise dose of water that is delivered by the drippers to the plant cubes.

Since each grow panel includes an array of plants, the plants can be considered to be arranged in rows and columns within the grow panel. In some embodiments, there is a single dripper 1130 for each grow panel column of plants. Thus, since grow panel 1000 includes six columns of plant cubes, secondary conduit 1120 can include six drippers, one located directly a corresponding plant cube in the top row of grow panel 1000.

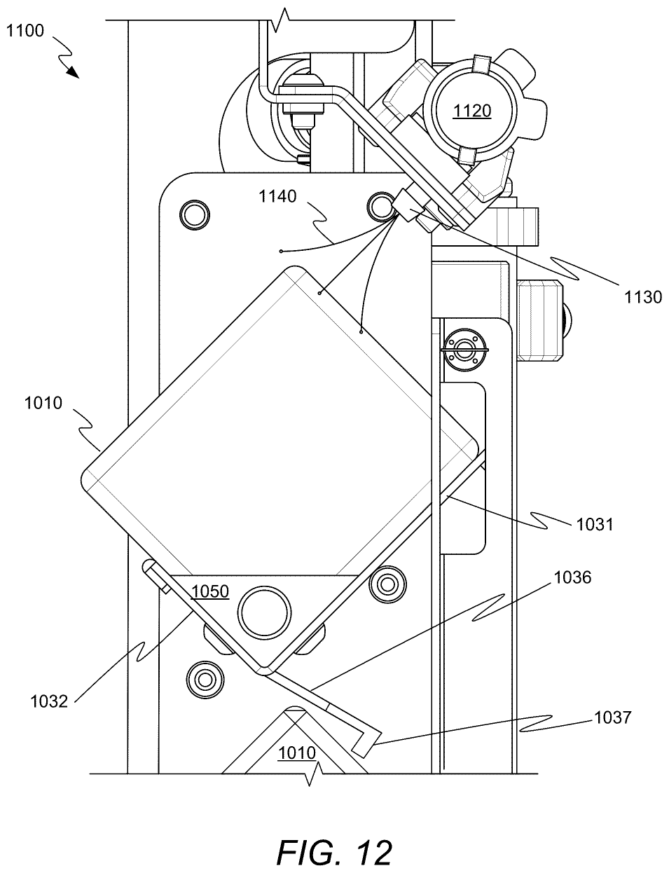

Grow panels 1000 and irrigation system 1100 can be designed so that water from each dripper 1130 cascades from the top row of plants down to the bottom row of plants in grow panel 1000 saturating the plant cubes in each of the intermediate rows of plant cubes in the grow column as shown in FIG. 13, which is a simplified diagram illustrating a flow 1300 of water from irrigation system 1100 through a grow panel installed in a grow module according to some embodiments. To assist in the cascading flow of water through the column, grow panel 1000 includes tongues 1036 and openings 1038 formed through the seat 1032 of each trough. Tongues 1036 and openings 1038 are more clearly depicted in FIG. 11C, which is an exploded view of a portion of FIG. 11B depicting a tongue 1036 aligned with and extending away from an opening 1038 formed through seat 1032. One of the tongues 1036 and a dripper 1130 is also more clearly depicted in FIG. 12, which is a simplified side plan view illustrating a dripper 1130 aligned to direct a spray of irrigation water 1140 directly onto a plant cube 1010.

Referring to FIGS. 11C, 12 and FIG. 13, nutriated water 1140 can be sprayed, dripped or otherwise delivered from a dripper 1130 of irrigation system 1100 directly to the root mass of plants 1015 embedded within a plant cube 1010 in a top row of grow panel 1000. The water can seep through the plant cube and root mass and be guided by back 1031 and seat 1032 of top trough 1030 through an opening 1038 (FIG. 11C) positioned directly beneath the dripper on the opposite side (lower side) of plant cube 1010. As the water passes through the opening 1038 it can travel along tongue 1036. Once the water reaches a distal end of the tongue it then drips or flows down into the root mass of plants located on the next, lower row of the grow panel. This pattern repeats itself until the nutriated water flows through the last row of plants in grow panel 1000 at which point any remaining runoff can be fed into a collection trough or return conduit (not shown but represented by arrow 1350) that pipes the water back to a drain and/or waste water system for recycling.

In some embodiments, each tongue 1306 can have a concave shape along its length to funnel water that reaches the tongue towards the tip (distal end) of the tongue. In other embodiments, the tongue can be flat and surface tension of the water contains water that reaches the tongue to travel the length of the tongue until it flows or drips off the distal end into the root mass of the plant beneath the tongue. Additionally, in some embodiments removable dividers (e.g., dividers 1034) can be positioned between each plant cube in each row of the grow panel in order to isolate the vertical cascade of water formed within each column to its particular column or “channel” to prevent water from escaping laterally between columns and thus make sure that each column of plants is getting essentially the same volume of water.

In some embodiments, tongues 1036 can be positioned such that, when the plant cubes are rotated into the second position, each tongue 1038 is bent downwards towards the plant cube 1010 the next, lower row of plant cubes such that the tongue contacts (or comes close to contacting) the plant cube in its respective column to better secure the plant cubes in the row. In such embodiments, tongues 1036 provide two distinct functions: directing nutriated water to the root mass of plantings in lower rows and securing the plant cube directly beneath each tongue. In some embodiments, and as depicted in FIGS. 11C, 12 and 13, each tongue can include a finger 1037 that extends downward and away from the distal dip of the tongue to provide a more secure contact point between the tongue and the plant cube.

### Agricultural Facility With Multiple Grow Modules

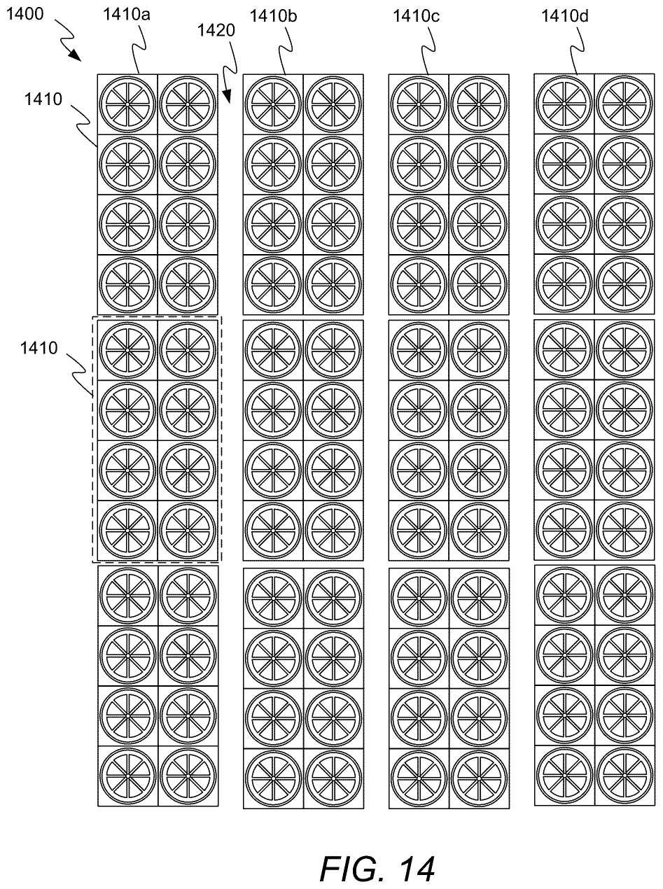

Some indoor agricultural facilities can include dozens, hundreds or more grow modules. FIG. 14 is a simplified schematic diagram of a portion of an indoor agricultural facility 1400 that can include hundreds of grow modules 1410 arranged throughout the facility in different rows. Any of the grow modules 100, 500a, 500b, etc. discussed above can be representative of the individual grow modules 1410. Shown in FIG. 14 are four different rows 1410a, 1410b, 1410c and 1410d of grow modules. A small corridor 1420 can be created between each of the separate rows to allow workers direct access to all the grow modules. Each individual grow module 1410 can be rotated by either motor or manually to allow the workers to install and remove grow panels from each grow module via the corridor 1420. In other embodiments, grow modules can be more tightly packed together in an array without corridors 1420 separating rows, and a gantry or similar structure can lift individual grow modules out of the array when grow panels are to be installed or removed.

In some embodiments, when multiple grow modules 1410 are installed in an agricultural facility, clusters of the grow modules can share different components. For example, as shown in FIG. 14, the grow modules 1410 can be arranged in clusters 1430 of eight grow modules 1410 that share various components such as central HVAC system and/or irrigation components. As a person of skill in the art will appreciate, the number of grow modules in a cluster as well as the type of shared components can vary in different embodiments.

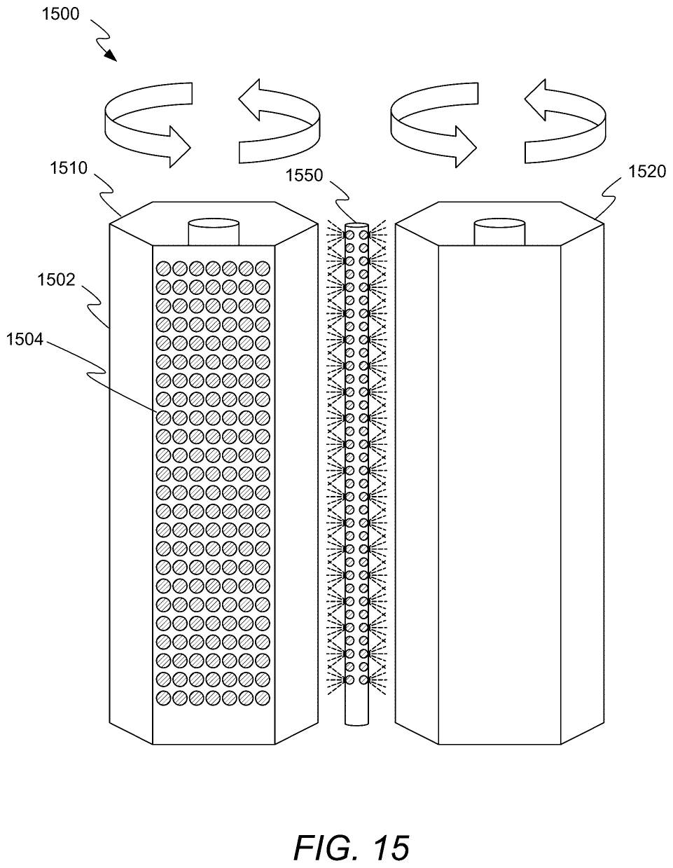

FIG. 15 is a simplified diagram of an agricultural facility 1500 that includes two grow modules that share a spray irrigation system according to some embodiments. As shown, agricultural facility 1500 includes first and second grow modules 1510 and 1520 that can be generally similar to the various embodiments of grow modules described above. Grow module 1510 is depicted as having an array of plant cubes 1504 installed in one column of a silo 1502. For case of illustration, similar plant cubes that can be installed in the other columns of grow module 1510 and in grow module 1520 are not shown.

Instead of having a drip irrigation system similar to irrigation system integrated into each grow module similar to irrigation system 1100 discussed above, grow modules 1510, 1520 share a spray irrigation system 1550 that can be positioned between the modules. Irrigation system 1550 can include a column within internal fluid conduit and a series of nozzles arranged radially around the column and along the height of the column. The nozzles can be coupled to the fluid conduit to receive nutriated water from a water source (e.g., a tank) within agricultural facility 1500 and direct a spray of the nutriated water to each of grow modules 1510, 1520 as shown. The grow modules can also each include a motor (now shown) that slowly rotates the silos during an irrigation cycle so that irrigation system 1550 can saturate the root masses (which face outward from the grow modules as described above) of all the plants within each grow module.

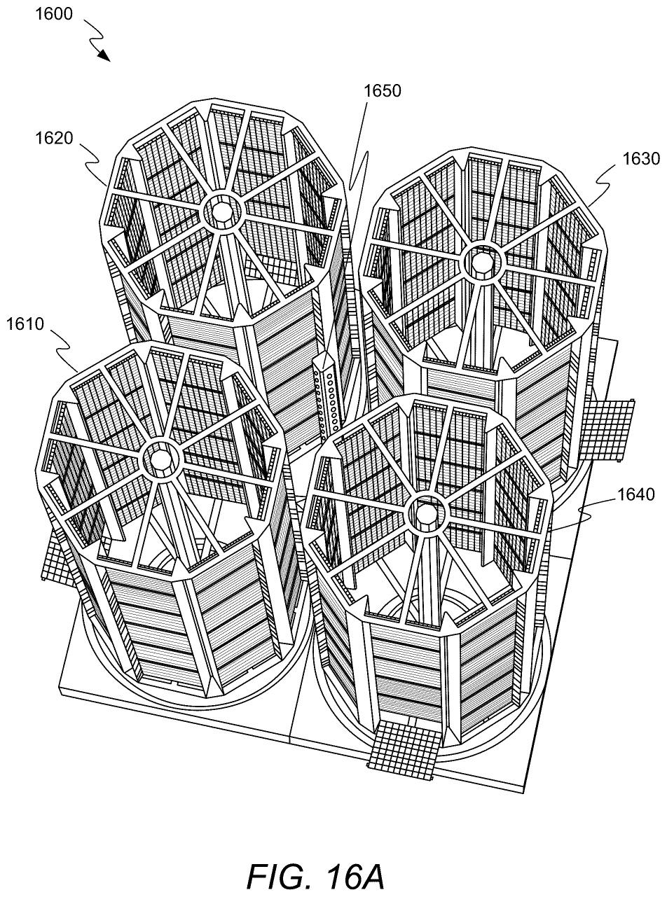

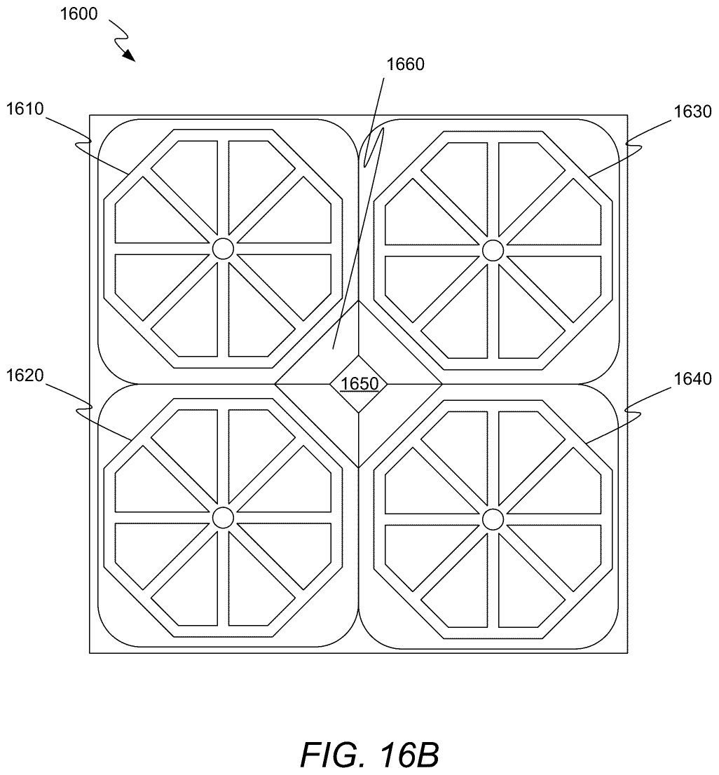

FIG. 16A is a simplified top perspective view of an agricultural facility 1600 with four grow modules that share a spray irrigation system according to some embodiments. As shown, agricultural facility 1600 includes four separate grow modules 1610, 1620, 1630 and 1640 that can be generally similar to grow modules 1410 and 1420. The four grow modules in facility 1600 are arranged in a square pattern with a shared spray irrigation system 1650 positioned between the modules. Irrigation system 1650 can be similar to irrigation system 1450 described and include a column with an internal fluid conduit and a series of nozzles arranged radially around the column and along the height of the column. The nozzles can be coupled to the fluid conduit to receive nutriated water from a water source (e.g., a tank) within agricultural facility 1600 and direct sprays of the nutriated water to each of grow modules 1610, 1620, 1630, 1640 as shown. The grow modules can also each include a motor (now shown) that slowly rotates the modules during an irrigation cycle so that irrigation system 1650 can saturate the root masses of all the plants within each grow module. Additionally, as shown in FIG. 16B, which is a top plan view of agricultural facility 1600, excess water from irrigating the grow modules can be collected in a drain 1660. As depicted, drain 1660 can include surfaces that surround column 1652 of the irrigation system and are sloped downward to funnel excess water into a fluid conduit that carries the drained fluid to a water sump tank, recycling system or similar system.

### Additional Embodiments

The foregoing description, for purposes of explanation, used specific nomenclature to provide a thorough understanding of the described embodiments. However, it will be apparent to one skilled in the art that the specific details are not required in order to practice the described embodiments. As one examples, while some embodiments of irrigation systems described above discussed drippers (drip emitters) for delivering nutriated water to plants, other types of emitters can be used including spray nozzles, sprinklers and the like. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings including using the various aspects, embodiments, implementations or features of the described embodiments separately or in any appropriate combination.

Various aspects of the described embodiments can be implemented by software, hardware or a combination of hardware and software. The described embodiments can also be embodied as computer readable code on a computer readable medium for controlling operation of the disclosed speaker. For example, the systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

What is claimed is:

1. A vertically-oriented module for growing plants, the module comprising:
a base comprising a housing for one or more auxiliary systems that support the module;
a silo positioned on top of the base, the silo comprising:
a central core;
an outer frame surrounding the central core, the outer frame defining a plurality of columns arranged radially around the central core, wherein each column is configured to receive one or more removable panels of plants; and
a plurality of lighting units coupled to and arranged radially around the central core such that each lighting unit projects light away from the central core towards a corresponding column in the outer frame.

2. The vertically-oriented module for growing plants set forth in claim 1 wherein the one or more auxiliary systems housed in the base comprise air handling components, irrigation piping and electronics for the module.

3. The vertically-oriented module for growing plants set forth in claim 1 wherein each lighting unit in the plurality of lighting units is spaced directly opposite a unique one of the plurality of columns defined by the outer frame and comprises a plurality of lighting elements arranged along a height of the central core.

4. The vertically-oriented module for growing plants set forth in claim 1 wherein each lighting unit comprises a plurality of elongated LED bulbs including a first subset of one or more LED bulbs arranged in a central region along a height of the central core and a second subset of LED bulbs that includes a first LED bulb disposed between a bottom of the central core and the first subset of LED bulbs and a second LED bulb disposed between a top of the central core and the first subset of LED bulbs, and wherein each of the one or more LED bulbs in the first subset of LED bulbs includes a plurality of symmetrically arranged LEDs and each of the LED bulbs in the second subset of LED bulbs includes a plurality of asymmetrically arranged LEDs.

5. The vertically-oriented module for growing plants set forth in claim 2 wherein the air handling components comprise an air control unit to distribute temperature controlled air to the module, and wherein the module further comprises a plurality of sets of nozzles spaced apart at even intervals along a height of the central core, wherein each set of nozzles comprises a plurality of individual nozzles configured to direct a flow of air from the air control unit towards the outer frame.

6. The vertically-oriented module for growing plants set forth in claim 5 further comprising an adjustable air vent at a top of the silo that can be moved between opened and closed positions to adjust a pressure level within the silo.

7. The vertically-oriented module for growing plants set forth in claim 1 further comprising a plurality of air ducts arranged between the base and the silo to allow air flow from the air handling components into the silo.

8. The vertically-oriented module for growing plants set forth in claim 1 wherein the outer frame defines a plurality of panel receiving slots arranged vertically within each of the plurality of columns from a bottom of the silo to a top of the silo, wherein each panel receiving slot is configured to removably receive a panel comprising an array of plants.

9. The vertically-oriented module for growing plants set forth in claim 8 wherein the module further comprises, at each panel receiving slot, a hinge element positioned adjacent a lower edge of the panel receiving slot and a latch element positioned adjacent an upper edge of the panel receiving slot.

10. The vertically-oriented module for growing plants set forth in claim 8 further comprising a plurality of grow panels, each grow panel sized and shaped to be inserted within and removably coupled to one of the plurality of panel receiving slots, and wherein each grow panel is configured to support a two-dimensional array of plants within its corresponding panel receiving slot such that a root mass of the plants faces outward away from the outer frame and a stem and leaves of the plants extend within the silo and face inward towards the central core.

11. The vertically-oriented module for growing plants set forth in claim 10 wherein each grow panel comprises a rectangular frame and an array of planting substrates disposed within the frame and is configured to rotate the array of planting substrates within its frame between a first position and a second position wherein, in the first position, the array of planting substrates is aligned to allow plants to grow perpendicularly away from the grow panel frame, and in the second position, the array of planting substrates is aligned to allow plants to grow away from the frame at an angle of between 20-70 degrees.

12. The vertically-oriented module for growing plants set forth in claim 8 further comprising an irrigation system comprising:
a primary conduit configured to be fluidly coupled to a pump house and extending within the central core to a top portion of the silo;
a plurality of secondary arteries fluidly coupled to the primary conduit at the top portion of the silo, wherein each of the plurality of secondary arteries extends radially away from the primary conduit in different directions along the top of the silo and down at least a portion of a height of the silo frame;
a plurality of veins fluidly coupled to each of the secondary arteries at different locations along the height of the silo frame; and
a plurality of drippers fluidly coupled to each of the plurality of veins.

13. The vertically-oriented module for growing plants set forth in claim 12 wherein:
each grow panel comprises a plurality of planting substrates are arranged in a two-dimensional array having a plurality of rows;
each of the plurality of drippers is disposed directly adjacent to a top row of planting substrates in the two-dimensional array;
the irrigation system is configured to allow water introduced by the drippers to cascade down from the top row of the array to each successive row before being recaptured and delivered through piping of the irrigation system to a wastewater tank.

14. The vertically-oriented module for growing plants set forth in claim 13 wherein each grow panel comprises a plurality of troughs within its frame, each trough supporting the plant substrates within one row of the array of planting substrates, and wherein the plurality of troughs include openings and tongues that direct water received at the trough to plant substrates directly beneath each trough.

15. The vertically-oriented module for growing plants set forth in claim 14 wherein the tongues in the troughs in a given row of a grow panel are bent downwards towards the plant substrates in the row beneath the given row such that the tongues help secure the plant substrates in the grow panel when the plant substrates are in the second position.

16. The vertically-oriented module for growing plants set forth in claim 1 further comprising a motor operatively coupled to rotate the silo above the base.

17. A vertically-oriented module for growing plants, the module comprising:
a base comprising a housing for one or more of air handling components, irrigation piping and electronics for the module;
a silo positioned on top of the base, the silo comprising:
a central core;
an outer frame surrounding the central core, the outer frame defining a plurality of columns arranged radially around the central core;
a plurality of panel receiving slots arranged along a height of each column in the plurality of columns, wherein each panel receiving slot is configured to removably receive a panel comprising a two-dimensional array of planting substrates positioned within a rectangular panel frame; and
a plurality of lighting units coupled to and arranged radially around the central core such that each lighting unit in the plurality of lighting units is spaced directly opposite a unique one of the plurality of columns defined by the outer frame and projects light away from the central core towards a corresponding column in the outer frame.

18. The vertically-oriented module for growing plants set forth in claim 17 further comprising a plurality of grow panels, each grow panel sized and shaped to be inserted within and removably coupled to one of the plurality of panel receiving slots, and wherein each grow panel is configured to support a two-dimensional array of plants within its corresponding panel receiving slot such that a root mass of the plants faces outward away from the outer frame and a stem and leaves of the plants extend within the silo and face inward towards the central core.

19. The vertically-oriented module for growing plants set forth in claim 18 wherein each grow panel comprises a rectangular frame and an array of planting substrates disposed within the frame and is configured to rotate the array of planting substrates within its frame between a first position and a second position wherein, in the first position, the array of planting substrates is aligned to allow plants to grow perpendicularly away from the grow panel frame, and in the second position, the array of planting substrates is aligned to allow plants to grow away from the frame at an angle of between 35-55 degrees.

20. The vertically-oriented module for growing plants set forth in claim 17 further comprising:
a plurality of sets of nozzles spaced apart at even intervals along a height of the central core, wherein each set of nozzles comprises a plurality of individual nozzles configured to direct a flow of air towards the outer frame; and
an adjustable air vent at a top of the silo that can be moved between opened and closed positions to adjust a pressure level within the silo.
